(19) United States
(12) Patent Application Publication
(10) Pub. No.: US 2009/0193080 A1
(43) Pub. Date: Jul. 30, 2009

(54) METHOD AND SYSTEM FOR AUTOMATING ORGANIZATIONAL TASKS USING A WIRELESS NODE NETWORK

(75) Inventor: Robert L. Toscano, Cambridge, MA (US)

Correspondence Address: PVF -- INTUIT, INC.;c/o PARK, VAUGHAN & FLEMING LLP, 2820 FIFTH STREET, DAVIS, CA, 95618-7759, US

(73) Assignee: INTUIT INC., Mountain View, CA (US)

(21) Appl. No.: 12/019,166

(22) Filed: Jan. 24, 2008

(51) Int. Cl. G06F 15/16

(52) U.S. Cl. 709/204

(57) ABSTRACT

Some embodiments of the present invention provide a wireless node network that includes a set of portable devices associated with members of an organization and a set of client nodes. During operation, the client nodes detect the portable devices in the vicinity of the client nodes and send records of detected portable devices to the server. The records are then stored by the server and are subsequently used to automate organizational tasks for the organization.

### BACKGROUND

### Related Art

The present invention relates to techniques for automating organizational tasks using a wireless node network.

An organization, such as a corporation, may be distributed across multiple buildings, campuses, cities, and/or countries. Within such an organization, various collaborative working groups may be formed by assembling employees with different skill sets who work from different locations.

Various technologies can be used to facilitate collaboration between employees working from different locations, such as portable computers, email, web conferencing, document and content-management systems and remote support systems. These technologies enable employees working from different locations to collaborate on projects, participate in meetings, and/or perform other tasks together. However, existing collaboration techniques lack the ability to easily track an employee's location, meeting attendance, and/or time allocation. The lack of such information about employees may introduce delays, extra costs, and other inefficiencies into the organization's workflow. Consequently, collaboration within organizations may be facilitated by the automated collection of such tracking information.

### SUMMARY

Some embodiments of the present invention provide a wireless node network that includes a set of portable devices associated with members of an organization and a set of client nodes. During operation, the client nodes detect the portable devices located in the vicinity of the client nodes and send records of detected portable devices to a server. The records are then stored by the server and are subsequently used to automate organizational tasks for the organization.

In some embodiments, the records are used to create a predictive model of interaction within the organization.

In some embodiments, a learning technique is used to generate the predictive model.

In some embodiments, the information is at least one of a device identifier (ID), a username, a client node ID, a timestamp, and a signal strength at the node.

In some embodiments, each of the organizational tasks involve a location of the members, a meeting of the members, a proximity of the members to one another, an attendance record of the members, or an amount of interaction between members of the organization.

In some embodiments, the portable devices can be a mobile phone, a personal digital assistant (PDA), a portable computer, a portable media player, a global positioning system (GPS) transceiver, a Bluetooth device, an infrared wireless device, or a badge.

In some embodiments, the client nodes can be a computer, a wireless access point, a Bluetooth device, and an infrared wireless device.

### BRIEF DESCRIPTION OF THE FIGURES

FIG. 1 shows a wireless node network in accordance with an embodiment of the present invention.

FIG. 2 shows a system for generating a record of a portable device in accordance with an embodiment of the present invention.

FIG. 3 shows a server in a wireless node network in accordance with an embodiment of the present invention.

FIG. 4 shows a flowchart of the process of using a portable device in accordance with an embodiment of the present invention.

FIG. 5 shows a flowchart of using a client node in a wireless node network in accordance with an embodiment of the present invention.

### DETAILED DESCRIPTION

The following description is presented to enable any person skilled in the art to make and use the disclosed embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present description. Thus, the present description is not intended to be limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

Embodiments of the present invention provide a method and system for using a wireless node network within an organization, such as a business, company, or a nonprofit organization. The organization may include one or more members (i.e., employees) and one or more locations. For example, the organization may include multiple employees with different responsibilities and/or skill sets. In addition, the employees may be located in one or more offices, cubicles, conference rooms, break rooms, and/or other locations within the organization's workspace, and employees may change locations multiple times throughout the workday. Note that the organization's workspace may include multiple buildings and/or campuses throughout which the employees may be distributed.

In one or more embodiments of the present invention, a wireless node network is configured to collect tracking information for some or all of the employees in the workplace. In addition, the wireless node network may be configured to use the tracking information to automate organizational tasks related to employee attendance, time allocation, and/or employee tracking. The wireless node network may also generate a predictive model of interaction within the workplace and/or organization, which may be used to facilitate interaction and productivity within the organization.

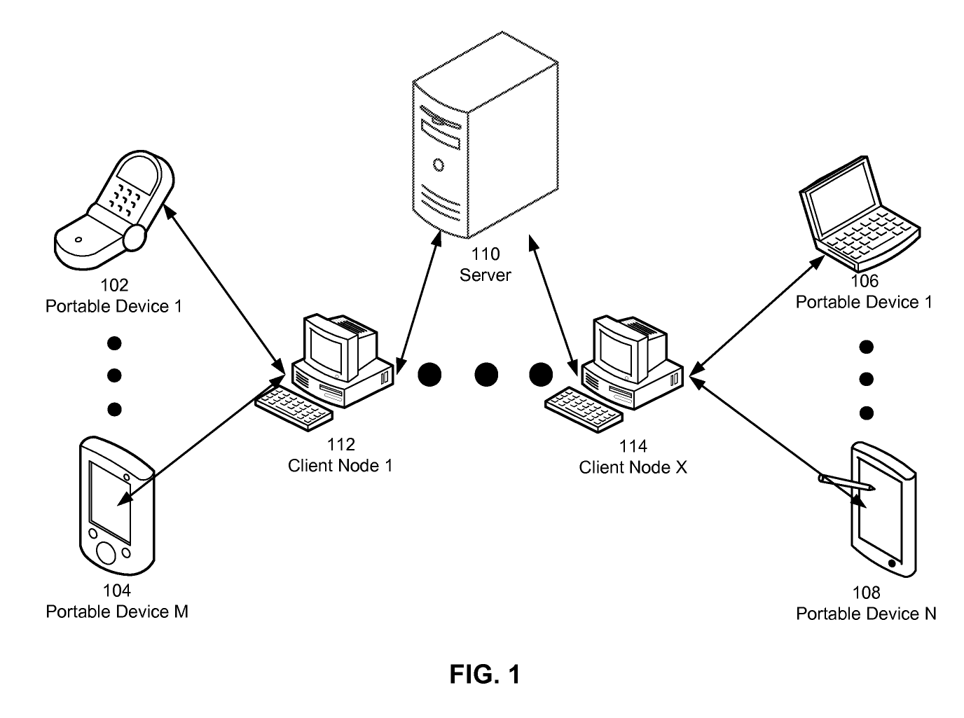

As shown in FIG. 1, the wireless node network includes a server 110, multiple client nodes (e.g., client node 1 112, client node x 114) distributed across locations in the organization, and multiple portable devices (e.g., portable device 1 102, portable device m 104, portable device 1 106, portable device n 108) that may be detected using the client nodes. Each of these components is described in more detail below.

Each of the portable devices may be a mobile phone, personal digital assistant (PDA), portable computer, portable media player, global positioning system (GPS) transceiver, Bluetooth device, infrared wireless device, badge (e.g., identification (ID) badge), and/or other wireless-enabled portable electronic device. Each portable device may be registered with the wireless node network. Furthermore, each portable device may also correspond to a member (e.g., employee) of the organization. For example, a member's mobile phone may be registered with the wireless node network using the mobile phone's Media Access Control (MAC) address and a username of the member. After registration, the portable devices may communicate with the client nodes using wireless protocols such as Bluetooth, infrared, and/or 802. 11.

In one or more embodiments of the invention, a list of registered portable devices and associated usernames is stored in server 110 and periodically transmitted to the client nodes for identification of detected portable devices. The client nodes may correspond to stationary devices within the organization. For example, a client node may be created using a stationary computer (e.g., desktop, workstation, etc.), a wireless access point, a Bluetooth device, and/or an infrared wireless device. In addition to communicating with the portable devices, the client nodes may also communicate with server 110 using one or more wired and/or wireless protocols. For example, the client nodes and server 110 may form a local area network (LAN) and/or intranet within the organization.

Those skilled in the art will appreciate that because the client nodes use wireless protocols to connect with the portable devices, each client node may only detect portable devices within range of the client node's wireless transceiver(s). In other words, client node 1 112 may detect portable device 1 102 through portable device m 104 because these portable devices are within the wireless range of client node 1 112. Client node x 114 may detect portable device 1 106 through portable device n 108 for similar reasons. In addition, a portable device may be detected by multiple client nodes if the portable device is within range of each of the client nodes. For example, a PDA in a hallway may be detected by desktop computers in nearby offices.

In one or more embodiments of the invention, the client nodes are configured to track the portable devices within the organization and/or workplace. Because each client node is stationary and can only detect portable devices within a certain range, each client node serves as an indicator of the detected portable devices' location. For example, a wireless access point mounted on a wall may serve as a pinpoint for all portable devices detected by the wireless access point. In addition, the portable devices may serve as tracking devices for the members of the organization as the members move around the workplace. For example, an employee may wear his/her ID badge at all times in the workplace. The ID badge may include a Radio Frequency ID (RFID) transmitter that is detected by various client nodes in the workplace as the employee moves around the workplace. Consequently, the employee's movement about the workplace may be tracked by the client nodes using his/her ID badge.

In one or more embodiments of the invention, each room (e.g., office, conference room, break room, etc.) in the workplace may include a client node. In addition, larger areas of space such as lobbies, hallways, parking garages, and/or lecture halls may include multiple client nodes distributed along the lengths, widths, and/or perimeters of the areas. Alternatively, a client node may be placed in each building or floor of a building for more generalized tracking of the employees. A portable device detected by a client node may represent a location of the associated employee within the immediate vicinity of the client node. Furthermore, a portable device's location may be triangulated if the portable device is detected by multiple client nodes. For example, a portable device that is detected by multiple client nodes may be assumed to be positioned within the perimeter defined by the client nodes. In addition, the signal strength of each client node with respect to the portable device may be used to more accurately determine the location of the portable device.

Once a portable device is detected by a client node, the client node generates a record of the tracked portable device. The record may include information such as a device ID of the tracked portable device, a client node ID of the tracking client node, a timestamp, and the signal strength at the client node with respect to the portable device. For example, the client node may identify a mobile phone by the mobile phone's MAC address. The client node may then access the list of registered portable devices obtained from server 110 and retrieve the member username corresponding to the mobile phone's MAC address. The client node may transmit the mobile phone's MAC address and/or associated username, a timestamp corresponding to the time of detection, the client node's Internet Protocol (IP) address, the client node's signal strength as detected by the portable device, and/or other information to server 110. Server 110 may then store the transmitted information as a record of the tracked portable device.

Those skilled in the art will appreciate that the wireless node network may include varying numbers of servers, client nodes, and/or portable devices. For example, the wireless node network may have multiple servers corresponding to multiple buildings and/or campuses of the workplace. Similarly, client nodes may be used to track employees with varying degrees of granularity. For example, a client node may be placed in every building of the workplace for general tracking of employees, or a client node may be placed in every room of the workplace for more accurate tracking. Moreover, each employee may be associated with multiple portable devices, any of which may be used to track the employee.

In one or more embodiments of the invention, tasks related to employee attendance, time allocation, and employee tracking are automated using the wireless node network. For example, the wireless node network may be used to automate tasks such as: regulating heating and lighting systems in the workplace; tracking employees' meeting attendance and sending meeting minutes to absent employees; enabling lookup of employees' locations in the organization's directory; providing proximity alerts of others approaching an employee's office and/or work area; and monitoring managers' time spent with employees.

Furthermore, the records may be processed to generate a predictive model of interaction within the organization, which may be used in other interaction-based applications for the organization. The predictive model may be generated by applying a learning technique such as a neural network, Bayesian network, Markov model, and/or other computational or statistical model. In addition, the predictive model may use the tracking information to make recommendations for matters such as scheduling meeting times, employees' presence at their work areas, and/or managers' allocation of time with employees and clients. Consequently, the wireless node network may allow interaction and/or location-based problems in the organization and/or workplace to be more efficiently solved. The automation of such organizational tasks may further facilitate productivity and decrease inefficiencies in the organization's workflow.

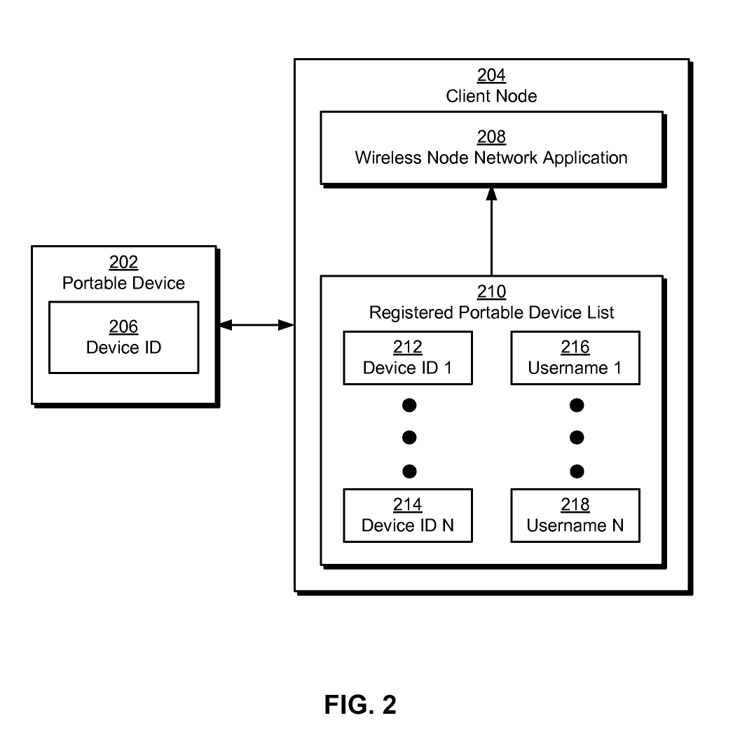

FIG. 2 shows a system for generating a record of a portable device in accordance with an embodiment of the present invention. More specifically, FIG. 2 shows a system of interaction between a portable device 202 and a client node 204 of a wireless node network, such as the wireless node network of FIG. 1. As mentioned previously, portable device 202 may be detected by client node 204 when portable device 202 is within a certain distance of client node 204. As a result, the detection of portable device 202 by client node 204 provides information regarding the location of portable device 202. Furthermore, because portable device 202 is assumed to be carried with an employee in the workplace, portable device 202 serves as a tracking device for the employee.

As shown in FIG. 2, client node 204 includes a wireless node network application 208, which may run as a background service by the operating system of client node 204 if client node 204 is a computer. On the other hand, the functionality of wireless node network application 208 may be integrated into firmware and/or hardware on client node 204 if client node 204 is a wireless access point and/or other specialized device. In one or more embodiments of the invention, wireless node network application 208 allows client node 204 to join the wireless node network and communicate with one or more servers in the wireless node network, such as server 110 of FIG. 1. In addition, client node 204 may obtain a registered portable device list 210 from the server(s) and monitor wireless frequencies for portable devices from registered portable device list 210.

In one or more embodiments of the invention, registered portable device list 210 contains a set of device IDs (e.g., device ID 1 212, device ID n 214) and a set of usernames (e.g., username 1 216, username n 218). In one or more embodiments of the invention, each registered portable device in the wireless node network is associated with a device ID and a username. The device ID may correspond to a unique identifier for the portable device, such as a MAC address. The username may associate the portable device with a particular user, thereby allowing the user to be tracked using the portable device. For example, the portable device may be registered by typing the device ID and usemame into a website. The device ID and usemame may then be sent to the server for storage, then to client node 204 for detection of the portable device.

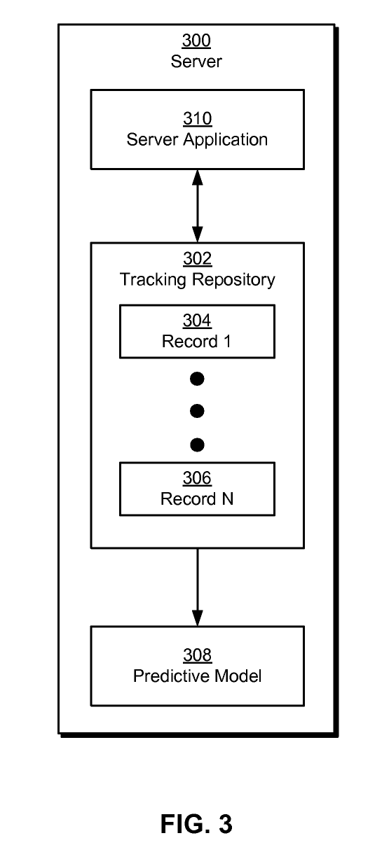

In one or more embodiments of the invention, portable device 202 is detected by client node 204 when portable device 202 is within range of the wireless transceiver of client node 204. Client node 204 may then obtain device ID 206 from portable device 202 and check registered portable device list 210 for device ID 206. If device ID 206 is found in registered portable device list 210, client node 204 may transmit device ID 206 and/or the associated username to the server as a record of the location of portable device 202. Client node 204 may also send additional information to the server, such as a client node ID, a timestamp, and/or a signal strength at client node 204 with respect to portable device 202. The record may be stored by the server and used in one or more applications, as described below with respect to FIG. 3.

FIG. 3 shows a server 300 in a wireless node network in accordance with an embodiment of the present invention. As shown in FIG. 3, server 300 includes a tracking repository 302, a predictive model 308, and a server application 310. In one or more embodiments of the invention, tracking repository 302 is stored in a relational database, such as a Structured Query Language (SQL) database. In addition, tracking repository 302 includes a set of records (e.g., record 1 304, record n 306) obtained from client nodes in the wireless node network. As described above, the records include location-based information about portable devices in the wireless node network and allow members of an organization to be tracked using the portable devices.

In one or more embodiments of the invention, server application 310 enables communication with the client nodes. Specifically, server application 310 processes incoming requests from the client nodes and makes records from tracking repository 302 available to the client nodes and/or other devices. Server application 310 may also handle registration of portable devices through a web interface and transmit updated lists of registered portable devices to the client nodes. The registered portable device list(s) may be stored in tracking repository 302 or in a separate repository.

Server 300 may also generate predictive model 308 from records in tracking repository 302. As mentioned previously, predictive model 308 may be generated using a learning technique such as a Bayesian network, neural network, and/or Markov model. Predictive model 308 may also be used to make recommendations regarding interaction between members of an organization, thus allowing more efficient interaction within the organization.

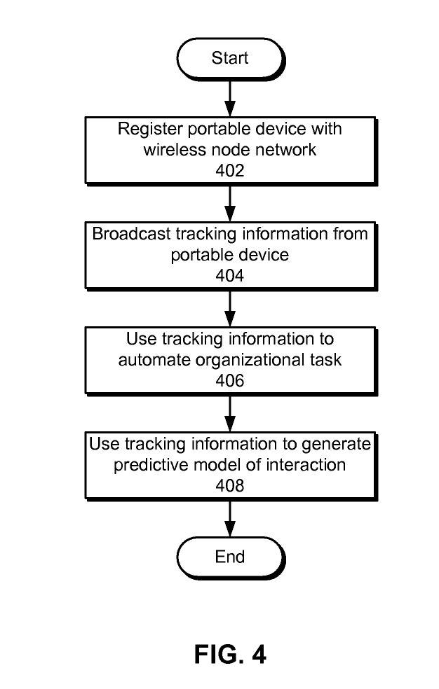

FIG. 4 shows a flowchart of the process of using a portable device in accordance with an embodiment of the present invention. In one or more embodiments of the invention, one or more of the steps may be omitted, repeated, and/or performed in a different order. Accordingly, the specific arrangement of steps shown in FIG. 4 should not be construed as limiting the scope of the invention.

Initially, a portable device is registered with a wireless node network (operation 402). The portable device may be a mobile phone, portable computer, PDA, GPS transceiver, Bluetooth device, infrared wireless device, badge, and/or other portable electronic device. The portable device may be registered by entering a device ID of the portable device and a username of the portable device's user into a website. The user may further be a member and/or employee of an organization (e.g., business, nonprofit organization) associated with the wireless node network.

Tracking information is broadcast from the wireless device (operation 404). The portable device may use one or more wireless technologies, such as Bluetooth and/or infrared wireless to broadcast the tracking information. Alternatively, the tracking information may be passively communicated using technologies such as RFID. This tracking information may include the device ID, username, and/or a timestamp. In addition, the tracking information may be detected by a client node of the wireless node network and used to automate an organizational task for the organization (operation 406). For example, the tracking information may be used to perform human factors-related tasks such as employee tracking, employee attendance, and/or time allocation between members of the organization.

The tracking information may also be used to generate a predictive model of interaction within the organization (operation 408). The predictive model may be generated using a statistical and/or learning technique such as a Bayesian network, neural network, and/or Markov model. In addition, the predictive model may be used in additional applications for the organization, such as recommendations for scheduling meeting times and employee face time.

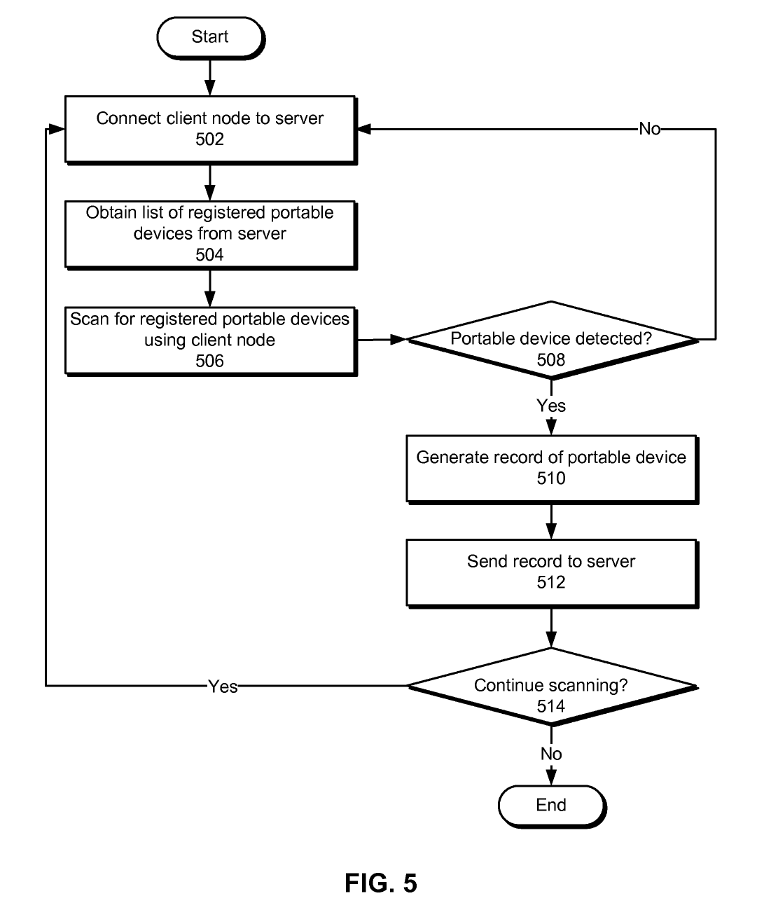

FIG. 5 shows a flowchart of using a client node in a wireless node network in accordance with an embodiment of the present invention. In one or more embodiments of the invention, one or more of the steps may be omitted, repeated, and/or performed in a different order. Accordingly, the specific arrangement of steps shown in FIG. 5 should not be construed as limiting the scope of the invention.

First, the client node is connected to a server in the wireless node network (operation 502). The connection may be made using a variety of wired and/or wireless protocols. The client node may also be created from a variety of stationary electronic devices, including a computer, wireless access point, Bluetooth device, and/or infrared wireless device.

Next, the client node obtains a list of registered portable devices from the server (operation 504). The list may include a device ID and username for each registered portable device. The device ID may be unique to the portable device (e.g., a MAC address), and the usemame may link the portable device to a particular user. In addition, the client node may use the list to scan for registered portable devices (operation 506) using one or more wireless protocols. Detection of a portable device (operation 508) on the registered portable device list may indicate that the portable device and associated user are in the vicinity of the client node. Consequently, the client node may track users through detection of their associated portable devices.

If no portable devices are detected, the client node is periodically connected to the server, the list of registered portable devices is updated, and the client node is used to scan for registered portable devices on the list (operations 502-506). Once a portable device on the registered portable device list is detected, a record of the portable device is generated (operation 510). The record may include information such as the device ID and/or usemame, a timestamp, a client node ID, and/or a signal strength of the client node as received by the portable device. The record is then sent to the server (operation 512) for storage. The record may also be used by the server or another host in the network to automate an organizational task for the users of the portable devices.

The client node may continue scanning for portable devices (operation 514) as long as the client node is a part of the wireless node network. To do so, the client node may connect to a server and obtain an updated list of registered portable devices (operations 502-504), scan for the registered portable devices (operations 506-508), and generate and send records of detected portable devices to the server (operations 510-512).

The foregoing descriptions of embodiments have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for using a portable device, comprising:
registering the portable device with a wireless node network, wherein the portable device is associated with a member of an organization;
broadcasting tracking information from the portable device to a client node in the wireless node network; and
using the tracking information to automate an organizational task for the organization.

2. The method of claim 1, further comprising:
using the tracking information to generate a predictive model of interaction within the organization.

3. The method of claim 2, wherein a learning technique is used to generate the predictive model.

4. The method of claim 2, wherein the tracking information includes at least one of a device identifier (ID), a username, a client node ID, a timestamp, and a signal strength at the node.

5. The method of claim 1, wherein the organizational task is associated with at least one of a location of the member, a meeting of the member, a proximity of the member to another member of the organization, an attendance record of the member, and an amount of time spent with another member of the organization.

6. The method of claim 1, wherein the portable device is at least one of a mobile phone, a personal digital assistant (PDA), a portable computer, a portable media player, a global positioning system (GPS) transceiver, a Bluetooth device, an infrared wireless device, and a badge of the user.

7. A method for using a client node of a wireless node network, comprising:
connecting the client node to a server of the wireless node network;
obtaining a list of registered portable devices from the server;
scanning to detect a portable device from the list of registered portable devices; and
if the portable device is detected:
generating a record of the portable device; and
sending the record to the server,
wherein the record is associated with a member of an organization, and
wherein the record is used to automate an organizational task for the organization.

8. The method of claim 7, further comprising:
using the record to generate a predictive model of interaction within the organization.

9. The method of claim 8, wherein a learning technique is used to generate the predictive model.

10. The method of claim 7, wherein the record includes at least one of a device identifier (ID), a usemame, a client node ID, a timestamp, and a signal strength at the node.

11. The method of claim 7, wherein the organizational task is associated with at least one of a location of the member, a meeting of the member, a proximity of the member to another member of the organization, an attendance record of the member, and an amount of time spent with another member of the organization.

12. The method of claim 7, wherein the client node is at least one of a computer, a wireless access point, a Bluetooth device, and an infrared wireless device.

13. A wireless node network, comprising:
a server comprising a tracking repository;
a set of portable devices, wherein each of the portable devices is associated with one of a set of members of an organization; and
a set of client nodes configured to:
detect the portable devices in the vicinity of the client nodes; and
send records of detected portable devices to the server,
wherein the records are stored in the tracking repository, and
wherein the records are used to automate organizational tasks for the organization.

14. The wireless node network of claim 13, wherein the records are used to create a predictive model of interaction within the organization.

15. The wireless node network of claim 14, wherein a learning technique is used to generate the predictive model.

16. The wireless node network of claim 13, wherein the information is at least one of a device identifier (ID), a username, a client node ID, a timestamp, and a signal strength at the node.

17. The wireless node network of claim 13, wherein each of the organizational tasks involve at least one of a location of the members, a meeting of the members, a proximity of the members to one another, an attendance record of the members, and an amount of interaction between members of the organization.

18. The wireless node network of claim 13, wherein each of the portable devices is at least one of a mobile phone, a personal digital assistant (PDA), a portable computer, a portable media player, a global positioning system (GPS) transceiver, a Bluetooth device, an infrared wireless device, and a badge.

19. The wireless node network of claim 13, wherein each of the client nodes is at least one of a computer, a wireless access point, a Bluetooth device, and an infrared wireless device.

20. A computer-readable storage medium storing instructions that when executed by a computer cause the computer to perform a method for using a client node of a wireless node network, the method comprising:
connecting the client node to a server of the wireless node network;
obtaining a list of registered portable devices from the server;
scanning to detect a portable device from the list of registered portable devices; and
if the portable device is detected:
generating a record of the portable device; and
sending the record to the server,
wherein the record is associated with a member of an organization, and
wherein the record is used to automate an organizational task for the organization.

21. The computer-readable storage medium of claim 20, the method further comprising:
using the record to generate a predictive model of interaction within the organization.

22. The computer-readable storage medium of claim 21, wherein a learning technique is used to generate the predictive model.

23. The computer-readable storage medium of claim 20, wherein the record includes at least one of a device identifier (ID), a username, a client node ID, a timestamp, and a signal strength at the node.

24. The computer-readable storage medium of claim 20, wherein the organizational task is associated with at least one of a location of the member, a meeting of the member, a proximity of the member to another member of the organization, an attendance record of the member, and an amount of time spent with another member of the organization.

25. The computer-readable storage medium of claim 20, wherein the client node is at least one of a computer, a wireless access point, a Bluetooth device, and an infrared wireless device.
